(19) United States
(12) Patent Application Publication
(10) Pub. No.: US 2008/0217494 A1
(43) Pub. Date: Sep. 11, 2008

(54) TURNSTILE LOCKING SYSTEM

(76) Inventor: David M. SIMPSON, Las Vegas, NV (US)

Correspondence Address: JENNIFER J. RIEL, 711 E. Walnut Street, Suite 204, Pasadena, CA, 91101, US

(21) Appl. No.: 12/040,803

(22) Filed: Feb. 29, 2008

Related U.S. Application Data
(60) Provisional application No. 60/893,031, filed on Mar. 5, 2007.

(51) Int. Cl. F16M 13/00

(52) U.S. Cl. 248/205.1

(57) ABSTRACT

A turnstile locking system comprises: a first member which includes a face, two flanges attached perpendicularly to opposite edges of the face, and an aperture on each flange; a second member which includes a v-shaped face, two flanges attached to the v-shaped face, and an aperture on each flange; and a pin which includes a head and an aperture. The first member face may be flat or may include a triangular projection. The first and second members may be connected by one or more hinges. The locking system may further include a lock component, or any suitable lock such as a padlock may be used with the present invention. A turnstile locking method comprises: providing a turnstile locking system of the present invention; positioning the first and second members onto a turnstile; engaging the first and second members; inserting a pin through the flanges' apertures; inserting a lock component through the pin's aperture, and locking the lock component.

This application claims the benefit of priority under 35 U.S.C. §119 of provisional application Ser. No. 60/893,031, filed Mar. 5, 2007, the contents of which are hereby incorporated by reference.

### FIELD OF THE INVENTION

The present invention generally relates to locking systems. More particularly, the present invention relates to a turnstile locking system that locks a turnstile in place to prevent unauthorized ingress and egress.

### BACKGROUND

There are many different types of turnstiles used in various applications, each of which are designed to limit, prevent, or control the access of persons, animals, and vehicles into or out of various facilities. Some turnstiles prevent all access, some allow ingress but not egress, and some only allow a person to pass through once he has placed a ticket or token into a device attached to the turnstile. Some allow free access, but only allow one person at a time through, and are used to control the rate of access and/or count the number of people passing through. Some are waist-high (and are usually used in areas where guards are also used to patrol the area or oversee the ingress of people), and some are full height, anchored to both the floor and ceiling.

Turnstiles are used in subways to prevent people without tickets from entering, they are used as exits from government buildings (where the turnstile only turns one way and allows free egress but no ingress), and they are used at tourist attractions or theme parks. All have the intention of limiting the movement of pedestrians in or out of the area the turnstiles are protecting (and usually preventing the access of vehicles entirely).

### Types of Turnstiles

There are several different general types of turnstiles, which can be broken down into categories: tripod turnstiles, rotor turnstiles, and gate-style turnstiles. Tripod turnstiles use a device consisting of three projecting bars, wherein people push on the top bar to rotate it forward, allowing them to walk through, and one of the two remaining bars rotates back to the original position of the first bar, ready for the next person. These types of turnstiles are often designed so that the tripod device only rotates in one direction, allowing egress but not ingress, for example. Rotor turnstiles are similar to revolving doors; there is a pin in the center, around which a number of vertical panels rotate. People push on the vertical panels, rotating the entire device. These turnstiles usually only turn one way, and they sometimes allow for people to ingress and egress at the same time (when people are in different “compartments” divided by the vertical panels). Some styles allow people to rotate completely around the center pin, while others have a fixed barrier that prevents this. Finally, gate-style turnstiles are often simple hinged panels that only hinge in one direction. People may push on the hinge to pass through, at which point it will spring back into place for the next person.

Another important distinction of turnstiles is whether they are low-level (roughly waist-high, perhaps three or four feet high) or full-height turnstiles. Waist-high turnstiles, which are anchored only to the floor, allow the possibility of people jumping or climbing over the turnstile, bypassing it completely. They are usually used at locations with human oversight; for example, they are often used at subways or train stations where guards may be present. Full-height turnstiles, on the other hand, are usually anchored to both the floor and ceiling, and prevent any ingress or egress except through the turnstile (they are therefore used in narrow doors or passageways, or in conjunction with walls that prevent bypassing the turnstile). Such full-height turnstiles, which are customarily one-direction rotary turnstiles, may be used without human oversight, and are ideal for locations where they are used as extra exits when the property owner does not wish for unticketed or unauthorized persons to enter the premises through that point.

### Full-Height Uni-Directional Rotary Turnstiles

For the purposes of the present invention, the type of turnstile discussed is the full-height uni-directional rotary turnstile. This particular type of turnstile only rotates in one direction (e.g., clockwise when viewed from the top), and adds a fixed set of bars that prevent people from making a complete circuit around the turnstile. Specifically, this type of turnstile includes a vertical pole anchored to both the floor and ceiling. Protruding from the pole are a number of horizontal bars, arrayed in a vertical wall and spaced apart at some fixed distance (e.g., they may be approximately six inches apart) creating gaps small enough that people can not fit through. These horizontal bars run from near the ground to near the ceiling. Viewed from above, there may be three or more sets of these bars spaced at 120 degree intervals (in variations with four sets of bars, they would be spaced 90 degrees apart).

This rotary turnstile is embedded in a circular or other suitable housing, with gaps 180 degrees apart for entrance and exit. However, the turnstile is designed to allow travel through it in only one direction (e.g., egress but not ingress); therefore, a fixed set of bars is incorporated to prevent people from continuing around the turnstile after they pass the exit. This barrier includes a series of horizontal bars, arrayed in a vertical wall and spaced about six inches apart, and spaced so that the bars of the rotary turnstile may pass through the gaps unhindered. This fixed barrier is placed to prevent people from progressing from the “exit” gap in the housing to the “entrance” gap, but does not interfere with movement from the “entrance” gap to the “exit” gap. For example, in a view from above, where the rotary turnstile rotates only in a clockwise direction, people enter at the top (0 degrees), and exit at the bottom (180 degrees), and the fixed barrier would be placed to the left (at 270 degrees), preventing people from continuing clockwise past the exit back to the entrance and their starting point (and also preventing people from entering at the exit gap at 180 degrees and progressing to the entrance gap at 360 degrees/0 degrees).

### Uses of Turnstiles

As mentioned earlier, turnstiles are designed to control the ingress and/or egress of persons. Some are designed to require human oversight, and some are not. The full-height unidirectional rotary turnstiles described above are customarily used to allow the movement of persons in only one direction (either ingress or egress, but usually egress only) without human supervision. Such turnstiles are ideal at amusement parks or zoos, where customers must pay to enter at specific manned entrances (which usually use other types of turnstiles, such as low-level tripod styles), yet where the park operators want to allow convenient exits at multiple locations, without any added expense of guards patrolling those exits. Creating such additional exits also allows for quick egress in the event of fire or emergency, or when the park closes and many people are leaving simultaneously. These types of turnstiles are ideal for this application (as well as situations such as security check points at airports and government property where access must be regulated) since they (a) allow egress but not ingress, and (b) when placed properly (i.e. in a narrow passageway or gap in a wall), they require no or minimum human intervention or oversight and may completely prevent ingress and access to the property from the outside.

### Need For Turnstile Locking Mechanism

While full-height unidirectional rotary turnstiles are designed to prevent movement in one direction (usually ingress), there is a need in the art for an inexpensive, effective, affordable method of locking the turnstile in place, thus preventing both ingress and egress when desired. Such a device may be used to lock the turnstile during the night, during times when the facility the turnstile serves is closed, or when an extra level of security is desired.

The ideal device, once attached, would not require human oversight to effectively lock the turnstile. It would be easily portable, relatively inexpensive, and simple to use. Yet, it should securely lock the turnstile so as to completely prevent its rotation, and thus completely prevent any persons from passing through it. There is a need in the art for a device that fits these qualifications, and that can be easily attached and removed to rotary-style turnstiles without drilling holes or penetrating the ground, turnstile, or the surrounding property or otherwise damaging the turnstile or the surrounding property.

### Drawbacks and Potential Improvements

Currently, there is a lack of turnstile locking options in the field of art. Simple chains along with padlocks may be used to lock full-height rotary turnstiles, but chains suffer from a variety of drawbacks, including being unwieldy, not completely securing the turnstile, and being relatively easy to cut or bypass. Sometimes, electronic locking mechanisms are also used, but these devices are expensive, difficult to install, prone to failure, and reliant upon an uninterrupted power supply to work properly. Additionally, if such electronic locking mechanisms malfunction, such systems may be difficult to repair, and it is not always possible or feasible to have the unit repaired immediately. To adequately address security concerns, it is imperative to be able to quickly and effectively lock the turnstile.

There does not currently exist in the art a turnstile locking device that is easy to use, easily portable, non-damaging, inexpensive, effective in scenarios involving power outages or technical malfunctions, and yet completely secures the turnstile and is difficult to circumvent. The present invention, however, possesses each of these characteristics, and therefore fulfills a need in the art. Other advantages of the present invention will be apparent in light of the ensuing description of the present invention.

### SUMMARY

The present invention is directed to a turnstile locking system that securely locks a turnstile in place and prevents unauthorized parties from entering and exiting via a turnstile. The present invention also provides increased security as it is difficult to circumvent, and it provides a simple, easy-to-use, portable, non-damaging, feasible, and efficient method of locking a turnstile. Additionally, the present invention is ideal during power failures and addresses security concerns when a turnstile is experiencing mechanical or electrical malfunctioning. As such, the present invention provides a practical alternative to conventional turnstile locking systems and methods during malfunctions, or it may provide increased security as a supplemental locking device to existing turnstile locking mechanisms.

To achieve the foregoing and in accordance with the purposes of the present invention, the present invention is directed to a turnstile locking system that comprises a first member, second member, and a pin. The first member and second member are adapted for use on a full height rotary turnstile. One embodiment of the present invention is directed to a turnstile locking device that generally comprises: (1) a first member which includes a first member face, two flanges connected perpendicularly to opposite edges of the first member face, and an aperture on each flange, (2) a second member which includes a v-shaped face, two flanges attached to the v-shaped face, and an aperture on each flange, and (3) a pin which includes a head and an aperture. In one embodiment, the first member face is planar or flat, and the two flanges are perpendicular to the planar face. In an alternate embodiment of the invention, the first member face includes: a first section and a second section which are planar to each other and a triangular or tapered projection positioned in between the first and second sections; and the flanges are connected perpendicularly to the edges of the first and second sections of the first member face. Additionally, the first and second members may be connected to each other by one or more hinges. In additional embodiments, the locking system may further include a locking component such a padlock or a lock that is specially adapted for use with or manufactured as part of the locking system of the present invention. Yet, in further embodiments, the turnstile locking system may include a blocking structure or housing that would block the shackle of the lock component to provide further security and prevent circumvention.

Another aspect of the present invention is directed to a method of securing a turnstile in place, said method comprising: (A) providing a turnstile locking device that comprises: (1) a first member which includes a first member face, two flanges connected perpendicularly to the edges of the first member face, and an aperture on each flange, (2) a second member which includes a v-shaped face, two flanges attached to the v-shaped face, and an aperture on each flange, and (3) a pin which includes a head and an aperture; (B) positioning the first member and second member onto a turnstile; (C) engaging the first member and second member wherein the first member's flanges receive the second member's flanges such that the second member's flanges are placed over the first member's flanges and the apertures on all four flanges align forming a conduit; (D) inserting a pin through the conduit formed by the flanges' apertures such that the end of the pin which includes the aperture is inserted first; (E) inserting a locking component through the pin's aperture; and (F) locking the locking component to lock the turnstile in place. The first member and second member may be positioned onto the turnstile by sliding the two members into place or simply by maneuvering the members into place. When the first member and second member are engaged, they form a channel wherein a plurality of the turnstile bars are enclosed therein, thereby locking the turnstile in place. In certain embodiments of the invention, two frame bars of the turnstile and one turnstile bar are enclosed within the channel formed by the first member and the second member.

The above description sets forth a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects, and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 is a perspective view of the first and second members of a turnstile locking device in accordance with an embodiment of the present invention.

FIG. 2 is a perspective view of the first and second members of a turnstile locking device in accordance with an embodiment of the present invention.

FIG. 3 is a perspective view of the backside of a turnstile locking system in accordance with an embodiment of the present invention.

FIGS. 4A-B depict a turnstile locking device of the present invention in the open position in accordance with an embodiment of the present invention.

FIGS. 4C-D depict a turnstile locking device of the present invention in the closed position in accordance with an embodiment of the present invention.

FIG. 4E depicts a turnstile locking device of the present invention in the closed position wherein a pin is being inserted therein in accordance with an embodiment of the present invention.

FIG. 4F depicts a turnstile locking device of the present invention in the closed position wherein a pin is inserted therein in accordance with an embodiment of the present invention.

FIG. 4G depicts a side view of a turnstile locking device of the present invention in the locked position in accordance with an embodiment of the present invention.

FIG. 4H depicts a backside view of a turnstile locking device of the present invention in the locked position in accordance with an embodiment of the present invention.

FIG. 41 depicts a front view of a turnstile locking device of the present invention in the locked position in accordance with an embodiment of the present invention.

FIG. 5 illustrates a full-height rotary turnstile that may be used with an embodiment of the present invention.

FIG.5A illustrates the first and second members of a turnstile locking device of the present invention being positioned onto the turnstile shown in FIG. 5 in accordance with an embodiment of the present invention.

FIG.5B illustrates the first and second members of the turnstile locking device shown in FIG. 5A being engaged onto the turnstile shown in FIG. 5 in accordance with an embodiment of the present invention.

FIG. 5C illustrates the turnstile locking system shown in FIG. 5B in the locked position in accordance with an embodiment of the present invention.

FIGS. 6A-C illustrate the positioning of a turnstile locking system of the present invention onto a turnstile.

FIGS. 6D-E illustrate the engaging of the first member with the second member of the turnstile locking system shown in FIG. 6A.

FIGS. 6F-G illustrate the inserting of a pin through the turnstile locking system shown in FIG. 6A.

FIG. 6H illustrates a front view of the turnstile locking system shown in FIG. 6A with a pin inserted therein.

FIGS. 6I illustrates a rear view of the turnstile locking system shown in FIG. 6A with a pin inserted therein.

FIG. 6J illustrates the application of a locking component to the turnstile locking system shown in FIG. 6A.

FIG. 6K illustrates a rear view of the turnstile locking system shown in FIG. 6A in the locked position.

FIG. 6L illustrates a front view of the turnstile locking system shown in FIG. 6A in the locked position.

FIG. 7 is a perspective view of the first and second members of a turnstile locking device joined by one or more hinges in accordance with an embodiment of the present invention.

FIG. 8 is a perspective view of the first and second members of a turnstile locking device joined by one or more hinges in accordance with an embodiment of the present invention.

FIG. 9 is a perspective view of the turnstile locking system comprised of the first and second members shown in FIG. 8, in accordance with an embodiment of the present invention.

FIGS. 10A-B depict the turnstile locking system shown in FIG. 9 in an open position in accordance with an embodiment of the present invention.

FIG. 10C depicts the turnstile locking system shown in FIG. 9 in the closed position in accordance with an embodiment of the present invention.

FIG. 10D depicts the turnstile locking system in FIG. 9 in the closed position wherein a pin is being inserted therein in accordance with an embodiment of the present invention.

FIG. 10E depicts the turnstile locking system in FIG. 9 in the locked position in accordance with an embodiment of the present invention.

FIG. 11 illustrates a full-height rotary turnstile that may be used with an embodiment of the present invention.

FIG. 11A illustrates the first and second members of the turnstile locking system in FIG. 9 being positioned onto the turnstile shown in FIG. 11 in accordance with an embodiment of the present invention.

FIG. 11B illustrates the first and second members of the turnstile locking system in FIG. 9 being engaged onto the turnstile shown in FIG. 11 in accordance with an embodiment of the present invention.

FIG. 11C illustrates the turnstile locking system in FIG. 9 in the locked position in accordance with an embodiment of the present invention.

### DESCRIPTION OF THE INVENTION

In the following description of embodiments of the invention, reference is made to the accompanying drawings, which form a part of this application. The drawings show, by way of illustration, certain embodiments in which the invention may be practiced. It is to be understood that other embodiments may be utilized and modifications may be made without departing from the scope of the present invention. Also, it is to be understood that the phraseology and terminology employed herein are for the purpose of description and should not be regarded as limiting.

The order in which the steps are presented below is not limited to any particular order and does not necessarily imply that they have to be performed in the order presented. It will be understood by those of ordinary skill in the art that the order of these steps can be rearranged and performed in any suitable manner. It further will be understood by those of ordinary skill in the art that some steps may be omitted or added and still fall within the spirit of the invention.

For ease of reference, the following reference numbers are consistently used in the figures of the present application to depict various components and embodiments of the present invention.

### REFERENCE NUMBERS

10 first member
11 first flange on first member
12 second flange on first member
15 first member face
16 triangular projection on first member face
17 first section of first member face
18 second section of first member face
20 second member
21 first flange on second member
22 second flange on second member
25 second member face
31 aperture on first flange of first member
32 aperture on second flange of first member
41 aperture on first flange of second member
42 aperture on second flange of second member
50 pin
52 pin aperture
54 pin head
60 lock component
62 Hinge(s) joining first member and second member
72 length of first member
74 width of first member (distance between flanges on first member)
76 width of flange on first member
77 distance from first member flange to triangular projection
78 length of side of triangular projection
82 length of second member
84 side length of second member face
85 side length of second member face
86 width of flange of second member
87 second member width (distance between flanges on second member)
90 channel that encloses turnstile bars
92 turnstile
94 turnstile bar (bar on rotating component of turnstile)
96 turnstile frame bars (bars on stationary frame of turnstile)

### Turnstile Locking System

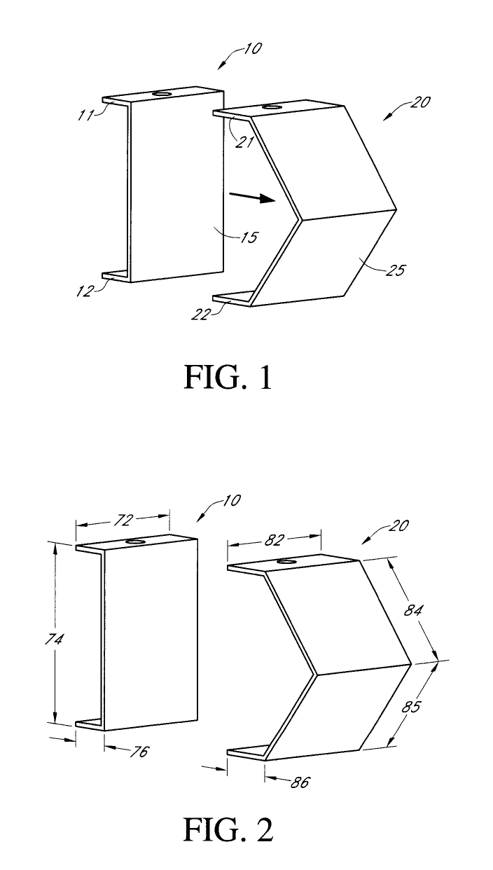

As depicted in FIG. 1, the turnstile locking system of the present invention is comprised of a first member 10 and a second member 20. The first member 10 includes a first member face 15 with first flange 11 and second flange 12 attached perpendicularly to the edges of first member face 15. In the embodiment depicted in FIG. 1, first member face 15 is of a planar or flat shape (although in alternate embodiments of the invention, first member face 15 may include a tapered or triangular projection that further secures the bars of a turnstile into place as discussed in more detail hereinbelow). The second member 20 includes a v-shaped second member face 25 and first flange 21 and second flange 22 adjoined to the edges of second member face 25.

FIG. 2 illustrates an example of the embodiment of the invention shown in FIG. 1. In this example, the turnstile locking system may have the following dimensions. The metal used for first and second members 10 and 20 may measure anywhere from ⅛ inch to ¼ inch thick, the first member length 72 is 6½ inches long, and the first member width 74 is 9½ inches wide. The first member width 74 is also the distance between the outer edges of flanges 11 and 12 (FIG. 1). The first member flange width 76 is 2¼ inches wide (and first member flange length is 6½ inches long—see first member length 72). In this example of the present invention, the second member length 82 is 6½ inches long, and side lengths 84 and 85 of the v-shaped second member face 25 are each 6½ inches long. The second member flange width 86 is 3 inches wide. However, it is to be noted that the locking device of the present invention may have a variety of dimensions and still fall within the scope of the invention. Of course, the measurements may vary depending on the turnstile's dimensions that the locking system is adapted for.

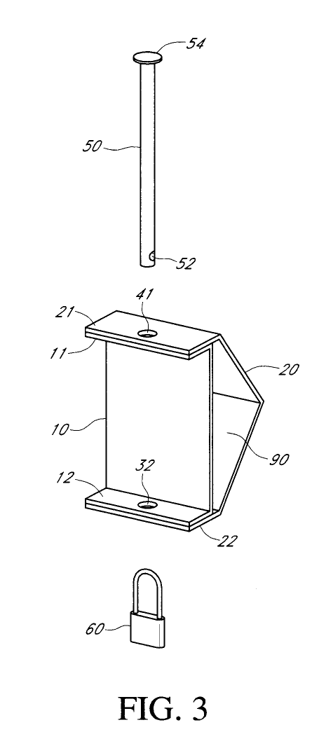

As seen in FIG. 3, the turnstile locking system of the present invention comprises a first member 10, second member 20, and a pin 50 which includes a pin head 54 and aperture 52. A lock component 60 may be included as part of the present invention wherein the lock component is manufactured as part of the invention or it is specially adapted for use with the present invention. Alternatively, for variations of the invention which do not comprise lock component 60, any variety of suitable locks such a padlock may be used with the present invention. In embodiments of the invention depicted in FIG. 2, the components may have a variety of dimensions. For example, pin 50 may be 11½ inches long and ¾ inches thick, pin head 54 may be 1½ inches in diameter, and aperture 52 may be ½ inches in diameter.

FIG. 3 shows the backside of the locking system of the present invention with first member 10 and second member 20 inter-engaged. When first member 10 and second member 20 inter-engage, flanges 11 and 12 of first member 10 receive flanges 21 and 22 of second member 20 such that flanges 21 and 22 are engaged over flanges 11 and 12 respectively, and the apertures of flanges 21, 11, 12, and 22 all line up to receive pin 50 therein. When first member 10 and second member 20 are engaged, they form a channel 90 wherein a plurality of turnstile bars are held, thereby locking the turnstile in place.

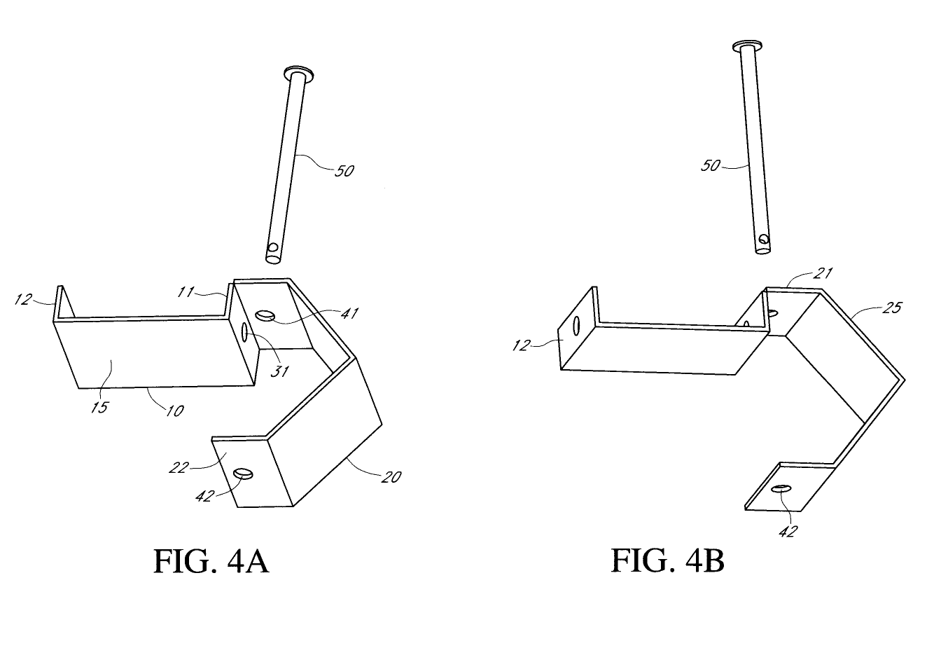

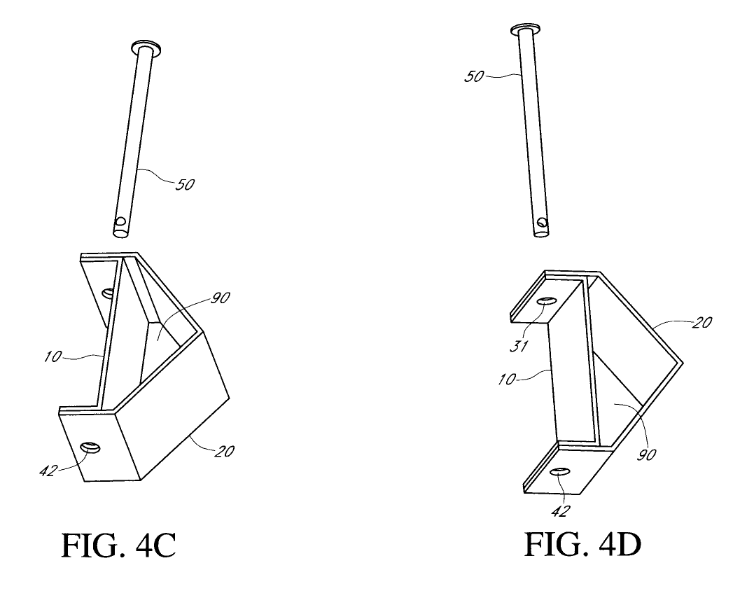

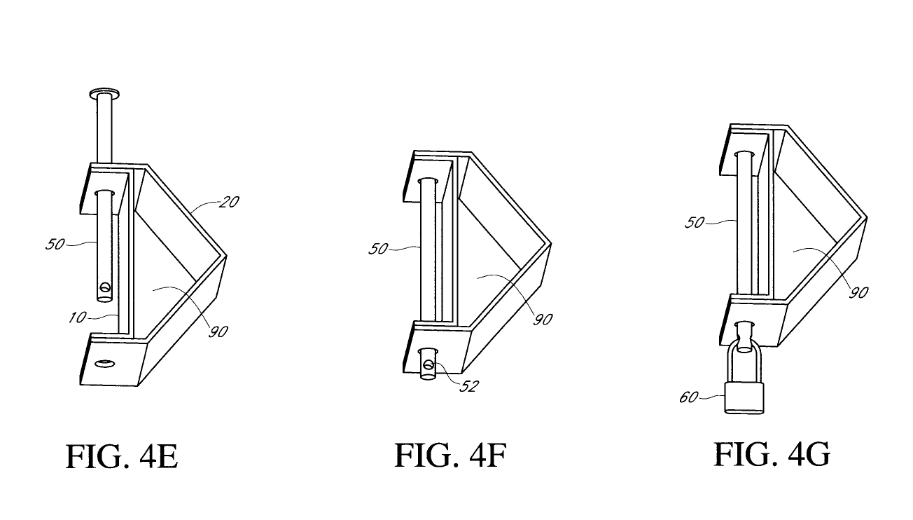

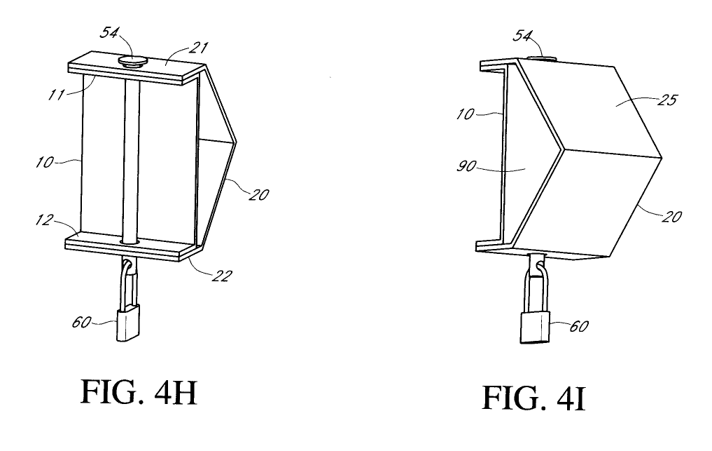

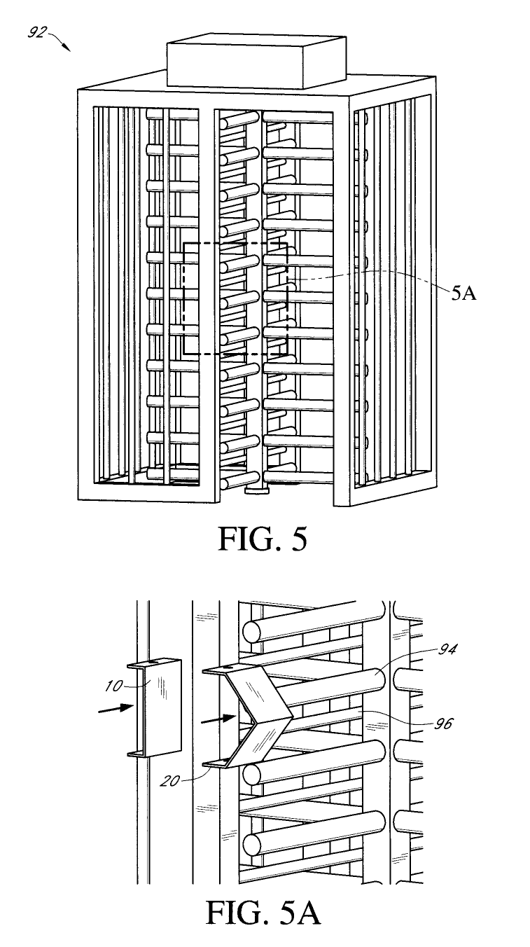

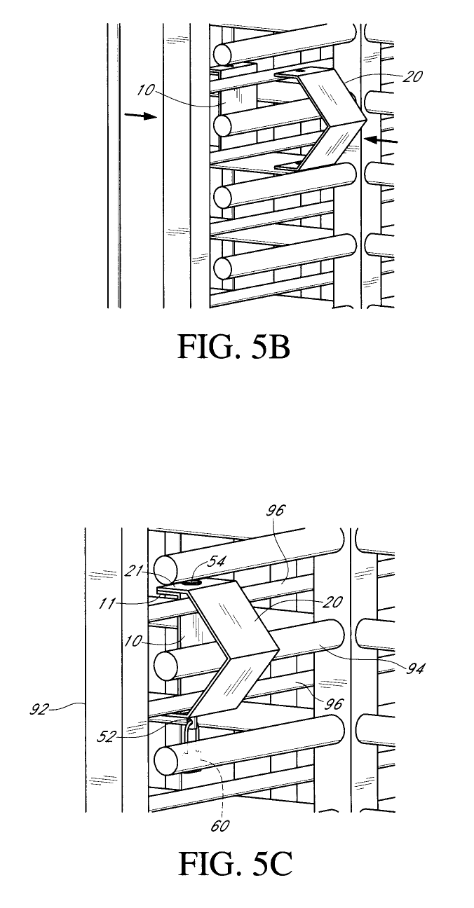

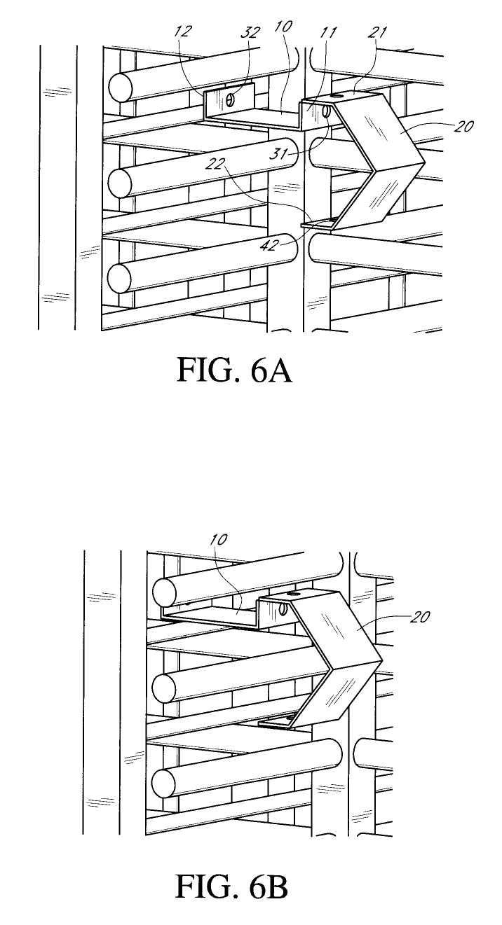

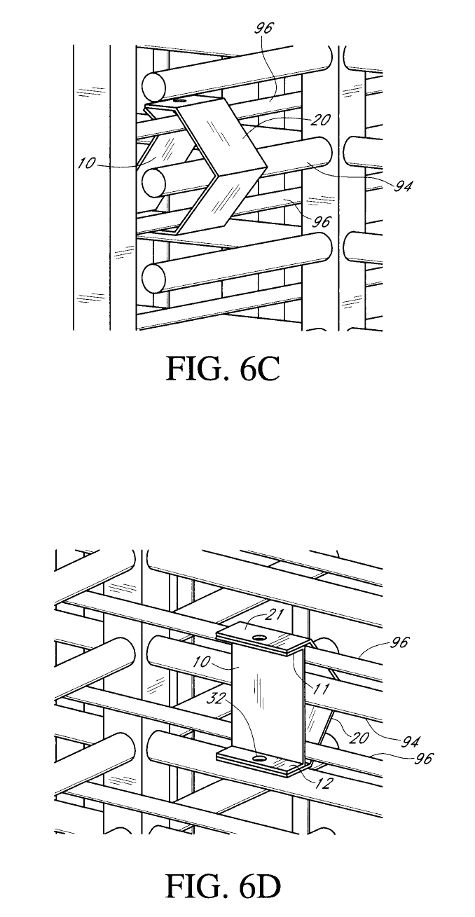

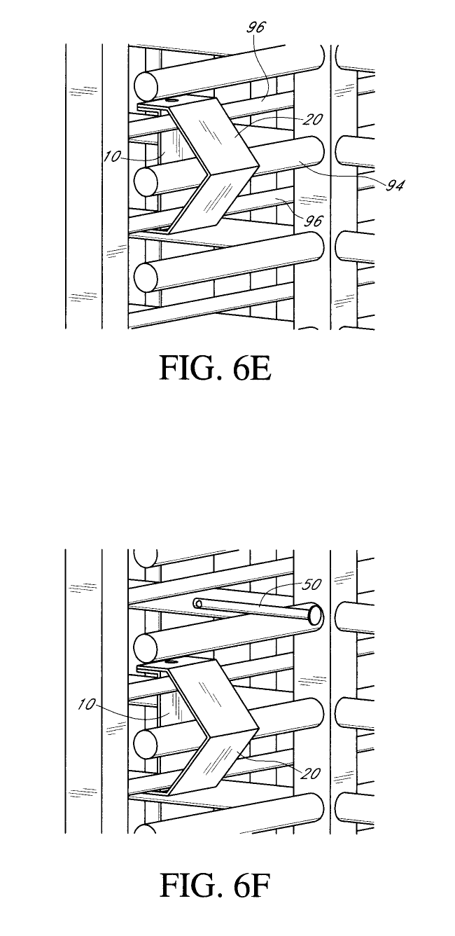

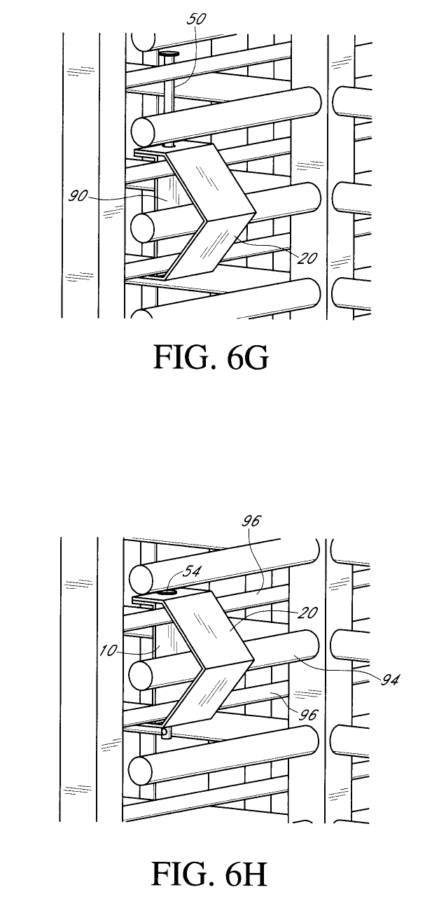

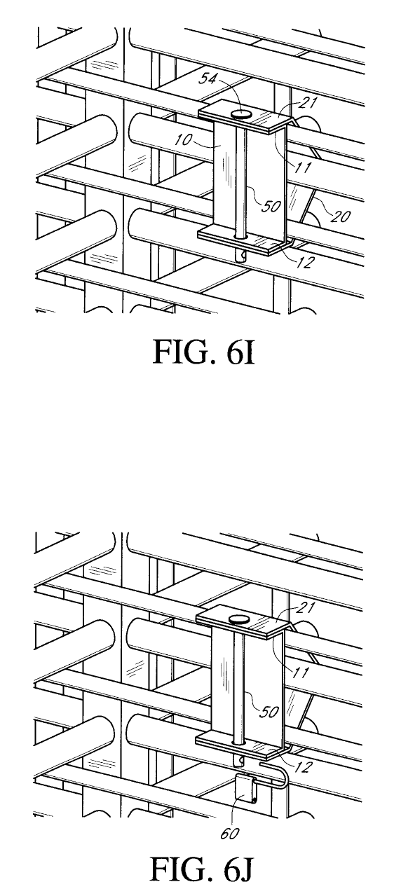

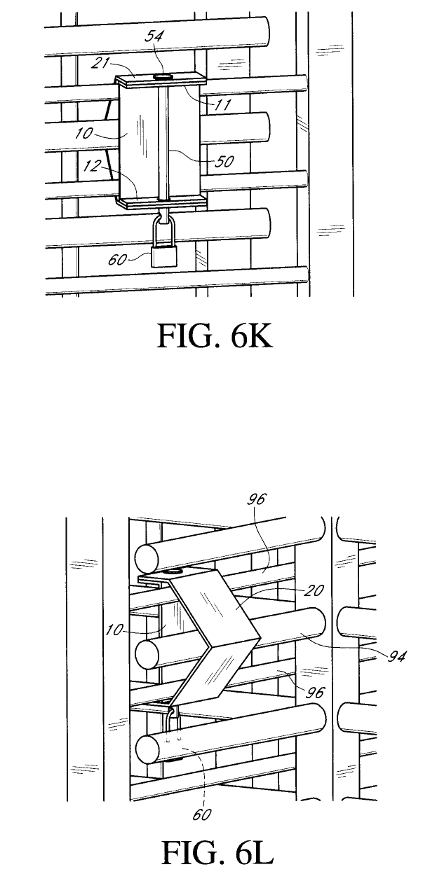

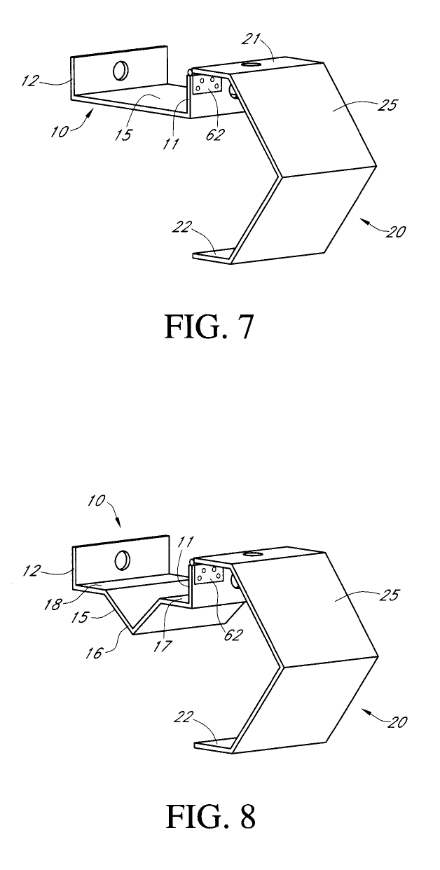

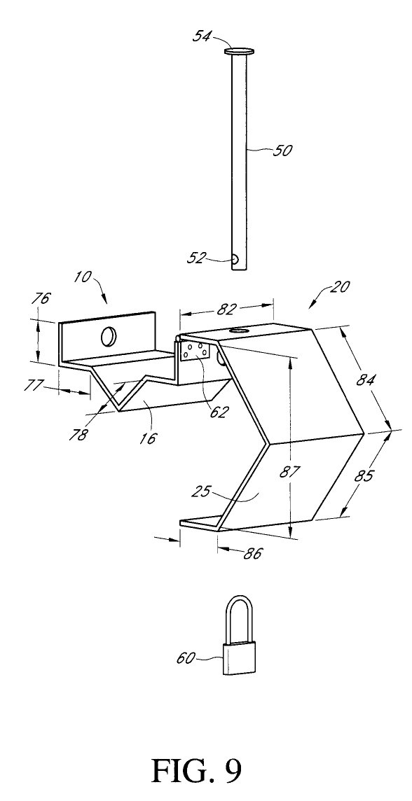

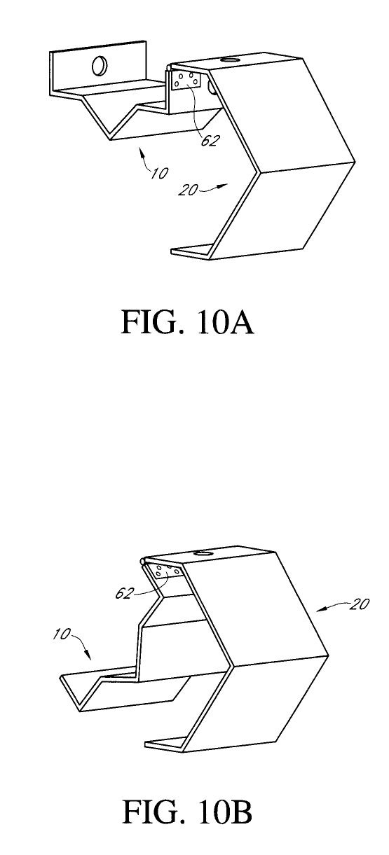

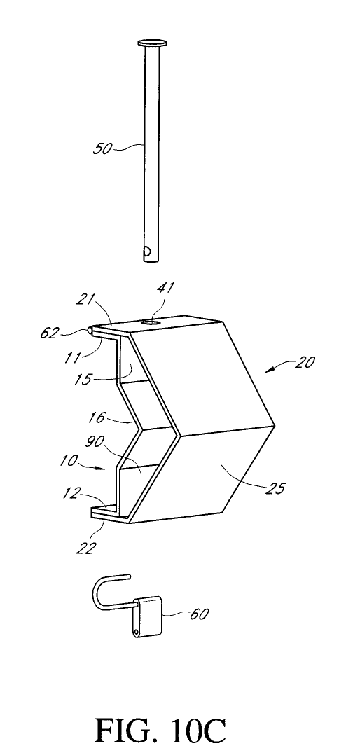

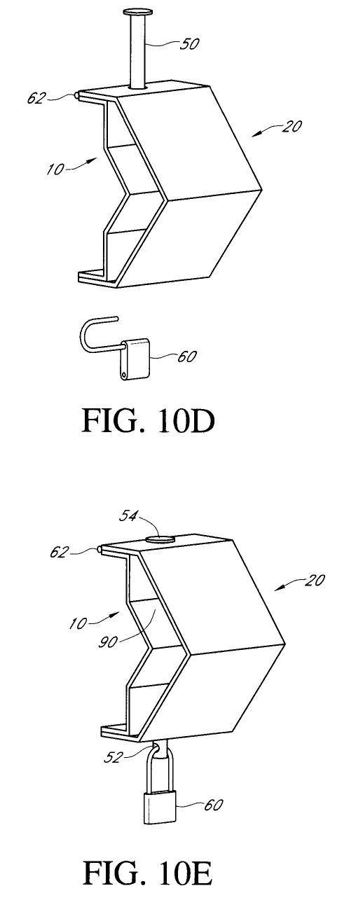

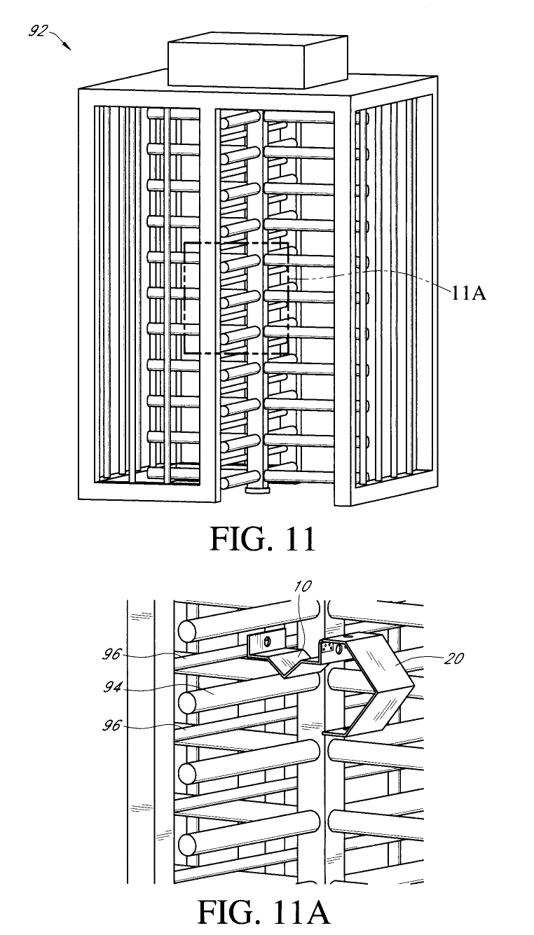

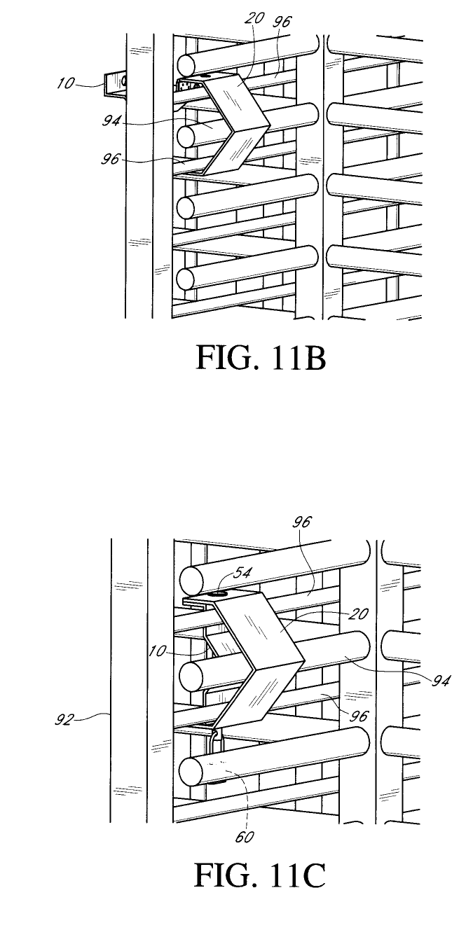

Still referring to FIG. 3, aperture 41 is located on flange 21 of second member 20. When first and second members 10 and 20 are engaged, aperture 31, which is located on flange 11 of first member 10 (see FIGS. 4A and 4D for a depiction of aperture 31), aligns directly underneath aperture 41 to receive pin 50. Aperture 42 is located on flange 22 of second member 20 (see FIGS. 4A-4D) while aperture 32, which is located on flange 12 of first member 10, aligns directly over aperture 42 to receive pin 50 when first member 10 and second member 20 are engaged. Apertures 41, 42, 31 and 32 may be of any suitable diameter to accommodate pin 50 to be inserted therein. For example, in one embodiment, apertures 41, 42, 31 and 32 may measure one inch in diameter to accommodate a pin with a ¾ inch diameter. In other embodiments, apertures 41, 42, 31 and 32 may also be of alternate shapes. For instance, apertures 41, 42, 31 and 32 may be oval, square, rectangular, or triangular to respectively accommodate a pin that has an oval-, square-, rectangular-, or triangular-shaped cross section. Additionally, the cross section of pin 50 may be solid or hollow (like that of a pipe).

FIGS. 4A-I depict a turnstile locking system in various positions in accordance with an embodiment of the present invention. FIGS. 4A-B illustrate the turnstile locking system in the open position (i.e., first member 10 and second member 20 are not engaged); FIGS. 4C-D depict a turnstile locking device in the closed position (i.e., first member 10 and second member 20 are engaged); FIG. 4E depicts a turnstile locking device in the closed position wherein a pin is being inserted therein; FIG. 4F depicts a turnstile locking device in the closed position wherein a pin is inserted therein; FIG. 4G depicts a side view of a turnstile locking device in the locked position (i.e., first member 10 and second member 20 are engaged and locking component 60 is inserted in pin aperture 52 and is locked); FIG. 4H depicts the back view of a turnstile locking device in the locked position; and FIG. 4I depicts a front view of a turnstile locking device in the locked position. FIGS. 4A-I also depict various views of first and second members 10 and 20, first member face 15, second member face 25, flanges 11,12,21, and 22, apertures 31, 41, and 42, pin 50, pin head 54, pin aperture 52, channel 90, and lock component 60.

Referring now to FIG. 7, first member 10 and second member 20 may be adjoined by one or more hinges in alternate embodiments of the invention. For instance, in one embodiment, two hinges may be used to adjoin first and second members 10 and 20, and in another embodiment, one hinge such as a piano hinge may be used. Hinges are not a necessary component for the purposes of the present invention to be achieved, but the inclusion of hinges can make it easier for a user to properly position first and second members 10 and 20 onto a turnstile and may decrease any pressure on the turnstile bars during the present invention's application.

As seen in FIG. 7, a locking system of the present invention is comprised of a first member 10 which includes a planar first member face 15 with flanges 11 and 12 attached perpendicularly thereto and second member 20 which includes a v-shaped second member face 25 with flanges 21 and 22 attached thereto. First and second members 10 and 20 are conjoined via flanges 11 and 21 which are connected by hinges 62. Depending on the embodiment of the invention, flanges 11 and 21 may be conjoined by one or more hinges so long as they do not block the apertures where the pin is inserted through.

FIG. 8 depicts another embodiment of the invention wherein the first and second members 10 and 20 are conjoined by one or more hinges. Like the embodiment depicted in FIG. 7, the locking system is comprised of first member 10 which includes a first member face 15 with flanges 11 and 12 attached thereto and second member 20 which includes a v-shaped second member face 25 with flanges 21 and 22 attached thereto. First and second members 10 and 20 are conjoined via flanges 11 and 21 which are connected by hinge 62, and depending on the embodiment of the invention, flanges 11 and 21 may be conjoined by one or more additional hinges. Although flanges 11 and 21 appear to be substantially flush in the embodiment depicted in FIG. 8, in alternate embodiments, hinge 62 may be attached on the inside between flanges 11 and 21 such that there is a slight gap between flanges 11 and 21 to accommodate the hinges.

In the embodiment of the present invention depicted in FIG. 8, first member face 15 of first member 10 includes a tapered or triangular projection 16 positioned in between a first section 17 and a second section 18 wherein the first and second sections 17 and 18 are planar to each other. First and second flanges 11 and 12 are respectively connected perpendicularly to the edges of the first and second sections 17 and 18 of first member face 15.

Triangular projection 16 further secures the bars of a turnstile into place. When first and second members 10 and 20 are engaged, the sides of triangular projection 16 parallel the sides of v-shaped second member face 25 (See FIG. 10C-E) to more securely enclose the bars of a turnstile therein thereby preventing movement of the turnstile. This embodiment allows first member face 15 and second member face 25 to be more flush with the turnstile bars that are enclosed therein, and thus permits little or no movement of the turnstile. The inclusion of triangular projection 16 on first member 10 may further and better encase the turnstile bars (in comparison to a first member face 15 being flat in alternate embodiments), may be less damaging to the turnstile since it permits little or no movement of the turnstile, and may enhance the integrity and strength of the locking system if rammed in during an attempt to circumvent the locking device. Thus, triangular projection 16 may provide enhanced security in comparison to alternate embodiments of the invention.

FIG. 9 illustrates an example of the embodiment of the turnstile locking device depicted in FIG. 8. In this variation of the invention, the following dimensions may be used. The metal used for first and second members 10 and 20 may be ⅛ to 1 inch thick, and first member flange width 76 is 2¼ inches wide. Distance 77 from first member flange to triangular projection 16 is 2½ inches. (Distance 77 also designates the width of second section 18 as well as first section 17 of first member face 15. See also FIG. 8). Triangular projection side length 78 is 3½ inches long. The second member length 82 is 6½ inches long, and second member width 87 is 10 inches wide. Second member width 87 is the distance between the flanges of the second member 20. Side lengths 84 and 85 of v-shaped second member face 25 are each 6½ inches long. The second member flange width 86 is 3 inches wide.

Still with reference to FIG. 9, in this example of the present invention, pin 50 is 11¾ inches long and one inch thick, pin head 54 is 1¾ inches in diameter, and pin aperture 52 is ½ inches in diameter. The apertures (not pictured in FIG. 9) on the flanges of the first and second members 10 and 20 are 1¼ inches in diameter which permits pin 50 to pass therein. In embodiments of the invention which incorporate two hinges, hinge 62 may be 2½ inches long and 1 inch wide or may have any other suitable dimensions. In embodiments of the invention wherein hinge 62 is ¼ inches thick, the space between the flanges of first member 10 may be between 9½ to 9¾ inches to accommodate the hinges and still be able to open and close within second member 20. Of course, depending on the specifications of the turnstile for which the locking system is built to accommodate or depending on the specifications of any one or more of the components of the invention, the components of the present invention may have any variety of suitable specifications and still fall within the scope of the invention.

FIGS. 10A-E illustrate the turnstile locking system depicted in FIG. 9 in various positions. In the embodiment shown in FIGS. 10A-E, first and second members 10 and 20 are joined together by one or more hinges 62. FIGS. 10A-B depict the turnstile locking system in an open position wherein first and second members 10 and 20 are not engaged. FIG. 10B depicts the locking device in the process of being engaged, but still in an open position. FIG. 10C depicts the turnstile locking system in the closed position. As seen in FIG. 10C, first and second members 10 and 20, which are held together by hinges 62, are engaged such that first member flanges 11 and 12 receive second member flanges 21 and 22 respectively, and second member 20 is engaged over first member 10. When in a closed position, the sides of triangular projection 16 parallel the sides of v-shaped second member face 25 of second member 20 to securely hold the turnstile bars in place. When engaged, first and second members 10 and 20 form a v-shaped channel 90 where a plurality of turnstile bars are enclosed therein. Also shown in FIG. 10C is a lock component 60 and aperture 41 located on flange 21 through which pin 50 pass therein. Lock component 60 may be included as part of the present invention wherein the lock component is manufactured as part of the invention or it is specially adapted for use with the present invention. Alternatively, for variations of the invention which do not include lock component 60, any variety of suitable locks such a padlock may be used with the present invention

FIG. 10D depicts the turnstile locking system in the closed position wherein pin 50 is being inserted therein, and FIG. 10E depicts the turnstile locking system in the locked position wherein pin 50 is fully inserted therein, pin head 54 is positioned on top of the locking device to hold pin 50 in place, and lock component 60 is inserted in pin aperture 52 and in the locked position.

The locking system of the present invention may be made from any suitable high strength material, preferably a metal such as steel. Ideally, the material should have the integrity and strength to prevent circumvention and destruction, withstand the elements, provide ample support, and securely lock the turnstile in place. As such, the present invention may be composed of a durable metal or metal composite such as steel, aluminum, titanium, zinc, combinations thereof, or any other durable material known to one skilled in the art.

Lock component 60, may be any suitable lock such as a detachable lock with a U-shaped bar or shackle hinged at one end that may pass through an aperture (e.g., padlock). In further embodiments of the invention, second member 20 may include at least one blocking element such as a metal casing, projection, box structure, or housing that would surround and/or block the shackle of lock component 60. The blocking element would prevent circumvention of the lock by a wire or lock cutter, saw, or file. Since the shackle would not be easily accessible, it would be difficult for someone to break or destroy the lock component.

In alternate embodiments of the invention, a customized lock that is specifically adapted for use with the locking system of the present invention may be used. For example, the lock component may be specially adapted for use with the present invention as a detached component. Alternatively, the lock may be manufactured to be part of either the first member or second member as opposed to a separate or external component. In other words, the lock component is manufactured as one piece with either the first or second member and is specifically adapted to lock the inter-engaged first and second members in place. In such embodiments, the pin and apertures found on the flanges may be eliminated from the locking system.

In further embodiments of the invention, the locking device of the present invention may further comprise a non-slip element. A non-slip element such as a rubber coating may be applied to any desired surface of the invention such as the interior walls of channel 90 that enclose the turnstile bars. These walls include first member face 15 and v-shaped second member face 25 (of first and second members 10 and 20 respectively) that form channel 90. The non-slip element (e.g., rubber material) provides sufficient frictional properties that would provide resistance to the locking device from slipping against the bars of the turnstile and to prevent any undesired noise and scratches or other damage to the turnstile during application of the device. In such embodiments of the invention a rubber coating of any suitable thickness (e.g., 1/8 inch thick) may be applied to the surfaces of the device that receive the turnstile bars.

Although the non-slip element is preferably a rubber material, it will be readily appreciated to those skilled in the art that the non-slip element may be composed of a variety of elements such as any polymer compound exhibiting a relatively high coefficient of friction. The non-slip element has a coefficient of friction that provides sufficient frictional force to provide resistance to movement of the locking device of the present invention when used against a hard surface. Examples of materials that may be used for the non-slip element may include, but are not limited to, natural rubber, synthetic rubber, latex rubber, silicone, plastic foam such as a polyurethane foam, foamed PVC, plastic material that is tacky, and combinations thereof. The non-slip element may be applied to the first and second members by a variety of methods. For instance, the non-slip element may be applied by direct application onto the first and second members, heat transfer, sprayed onto the first and second members, or by any other method known to those skilled in the art.

### Method of Locking a Turnstile

Another aspect of the present invention is directed to a method of securing a turnstile. In one embodiment of the present invention, a method for securing a turnstile comprises: (A) providing a turnstile locking device that comprises: (1) a first member which includes a first member face, two flanges connected perpendicularly to the edges of the first member face, and an aperture on each flange, (2) a second member which includes a v-shaped face, two flanges attached to the v-shaped face, and an aperture on each flange, and (3) a pin which includes a head and an aperture; (B) positioning the first member and second member onto a turnstile; (C) engaging the first member and 10 second member wherein the first member's flanges receive the second member's flanges such that the second member's flanges are placed over or coupled with the first member's flanges and the apertures on all four flanges line up forming a conduit; (D) inserting a pin through the conduit formed by the flanges' apertures such that the end of the pin which includes the aperture is inserted first; (E) inserting a lock component through the pin's aperture, and (F) locking the lock component to lock the turnstile in place. When the first member and second member are engaged, they form a channel wherein a plurality of the turnstile bars are enclosed therein, thereby locking the turnstile in place.

FIG. 5 depicts a full-height rotary turnstile that may be used with the present invention. As seen in FIG. 5A, in one embodiment of the present invention (which does not include one or more hinges connecting first member 10 to second member 20), first member 10 and second member 20 may be positioned onto turnstile 92 by sliding first and second members 10 and 20 into place. First and second members 10 and 20 are slid over one turnstile bar 94 and two turnstile frame bars 96. (For purposes of describing the embodiments described in FIGS. 5-6 and 11, “turnstile bar” refers to one of the bars on the rotating component of turnstile 92 and “turnstile frame bars” refer to bars on the stationary frame of turnstile 92. However, the term “turnstile bars” is sometimes used herein to collectively describe bars found on both the rotating turnstile component and turnstile frame. It is also to be noted that the present invention may be used on any suitable combination of turnstile bar and turnstile frame bars, and the application of the invention is not limited to one particular location on turnstile 92 and is not limited for use with any specific turnstile bar and/or turnstile frame bars.).

FIG. 5B illustrates the first and second members 10 and 20 being engaged onto turnstile 92. FIG. 5C illustrates the turnstile locking system in the locked position wherein: first and second members 10 and 20 are engaged such that second member flange 21 is positioned over first member flange 11 (second member flange 22 is positioned over first member flange 12 but it not shown in FIG. 5C) and turnstile bar 94 and two turnstile frame bars 96 are enclosed within first and second members 10 and 20; pin is inserted through the locking device such that pin head 54 is positioned on top of the locking system to hold the pin in place; and a lock component is inserted through pin aperture 52 and is in the locked position. Although FIGS. 5A-5C (as well as 6A-6J) depict the variation of the invention wherein first member face 15 is planar, the method of the present invention is carried out in the same or similar way for embodiments of the invention wherein first member face 15 includes a triangular projection 16 (see FIGS. 8-9).

FIGS. 6A-J depict another embodiment of the method of the present invention wherein first and second members 10 and 20 are positioned onto a turnstile by maneuvering first and second members 10 and 20 in between a plurality of turnstile bars. This method of the present invention may be carried out with either non-hinged variations (i.e., first and second members 10 and 20 are two separate pieces) or hinged variations (i.e., first and second members 10 and 20 are conjoined by one or more hinges) of the invention. In this embodiment, the method comprises: (a) positioning the turnstile locking system of the present invention onto a turnstile by maneuvering first and second members 10 and 20 in between turnstile bar 94 and two turnstile frame bars 96 (FIGS. 6A-C); (b) engaging first member 10 with second member 20 such that the flanges of second member 20 are engaged over flanges of first member 10 (FIGS. 6D-E); (c) inserting a pin 50 through the turnstile locking system of the present invention (FIGS. 6F-G) such that pin head 54 is positioned on top of the locking system and pin aperture 52 is at the bottom of the system to receive a lock therethrough (FIG. 6H illustrates a front view and FIG. 61 illustrates a rear view of the turnstile locking system with the pin inserted therein); and (d) applying a locking component 60 to the turnstile locking system by inserting the shackle of locking component 60 through pin aperture 52 (FIG. 6J).

FIGS. 6K illustrates a rear view and FIG. 6L illustrates a front view of the turnstile locking system of the present invention in the locked position. FIGS. 6A-L also depict various views of the locking system and its various components.

FIG. 11 illustrates a full-height rotary turnstile that may be used with the present invention. FIGS. 11A-C depict the method of the present invention with use of a hinged variation of the invention. FIG. 11A illustrates the first and second members of the turnstile locking system in FIG. 9 being positioned onto turnstile 92 by maneuvering first and second members 10 and 20 in between turnstile bar 94 and turnstile frame bars 96. In such variations of the locking system, the hinges may provide an easier alternative for a user to position first and second members 10 and 20 onto turnstile 92. Without proper instruction or in a case of an emergency situation, a user may have some difficulty positioning two separate (unhinged) members onto a turnstile and inter-engaging the two members. The hinges offer a user friendly approach whereas the first and second members 10 and 20, now conjoined, can easily be placed onto turnstile 92 and be inter-engaged to one another quickly while requiring little to no instruction.

FIG. 11B depict first and second members 10 and 20 being engaged with one another, and FIG. 11C illustrates the turnstile locking system in the locked position wherein first and second members 10 and 20 enclose a turnstile bar 94 and two turnstile frame bars 96. Although the illustrations used to depict the method of the present invention involve securing one turnstile bar 94 and two turnstile frame bars 96, other variations of the invention are possible and may depend on the structure and configuration of the turnstile. To secure the turnstile in place, a plurality of turnstile bars (combination of turnstile bar(s) and turnstile frame bar(s)) may be enclosed within channel 90 formed by first and second members 10 and 20 to thereby secure the turnstile in place.

The present invention includes a system and method for securing a turnstile that addresses the inadequacies of conventional systems and methods. It can be realized from the embodiments described herein that the present invention is designed to: securely lock the turnstile and prevent unauthorized parties from entering and exiting via the turnstile, provide increased security as it is difficult to circumvent, and provide a simple, easy-to-use, portable, non-damaging, feasible, and efficient method of locking a turnstile. The present invention is ideal during power failures and can quickly and efficiently address security concerns when a turnstile is experiencing mechanical or electrical malfunctions. The present invention provides a practical alternative to conventional turnstile locking systems and methods during malfunctions, or it may provide increased security as a supplement to existing turnstile locking mechanisms.

It is to be understood, that although some advantages of the present invention are described herein, it is not necessary that all the advantageous features and/or all the advantages need to be incorporated into every embodiment of the invention.

Although the present invention has been described above in considerable detail with reference to certain versions thereof, other versions are possible. For example, in alternate embodiments, a lock component and second member may be manufactured as one component wherein the lock component is specially designed or adapted for use with the locking system of the present invention, the lock component may be specially adapted for use with the present invention as a separate element of the invention, or the present invention may not include a locking component as the present invention may be universally adapted for use with any variety of suitable locking components such as a padlock.

Additionally, any of the angles of the locking device may be rounded; for instance, in some embodiments of the invention, the triangular or tapered projection of the first member may have a rounded edge as opposed to a sharp edge, or the v-shaped projection of the face of the second member may be u-shaped instead. A rubber coating may be added to the interior of the channel; and in other embodiments, the first and/or second members may include a blocking structure that provides increased security by blocking the shackle of the lock component to prevent someone from cutting or breaking the shackle. Also, the locking system of the present invention may include aesthetically pleasing features or designate a particular company or business for which the present invention is being used (e.g., theme park logos, sporting event mascots, airline trademark, etc.). Moreover, various coatings (e.g., powdercoat paint, spraypaint, or weather resistant coatings) may be applied, or the locking system may be customized to match any variety of turnstiles. In some embodiments, the locking system of the present invention may be plated with chrome, zinc, stainless steel, brushed aluminum, or any other suitable coating; or it may be painted with a variety of colors, textures, and/or designs.

Additionally, some steps of the turnstile securing method described herein may be added, omitted, modified, or performed in various sequences. Some of the steps identified in the embodiments described herein are for illustrative purposes, and as such, some of the steps may be modified, added, or omitted without departing from the scope of the invention.

While the description above refers to particular embodiments of the present invention, it will be understood that many modifications may be made without departing from the spirit thereof. The presently disclosed embodiments are therefore to be considered in all respects as illustrative and not restrictive.

1. A turnstile locking system comprising:
(a) a first member comprised of
a first member face,
a first member first flange,
a first member second flange,
a first member first aperture located on the first member first flange, and
a first member second aperture located on the first member second flange,
wherein the first member first flange and the first member second flange are connected perpendicularly to opposite edges of the first member face;
(b) a second member comprised of
a v-shaped second member face,
a second member first flange,
a second member second flange,
a second member first aperture located on the second member first flange, and
a second member second aperture located on the second member second flange,
wherein the second member first flange and the second member second flange are connected to opposite edges of the v-shaped second member face; and
(c) a pin comprised of a pin head and a pin aperture.

2. The turnstile locking system in claim 1 wherein the first member face is flat.

3. The turnstile locking system in claim 1 wherein the first member face comprises
a first section,
a second section, and
a triangular projection positioned in between the first section and the second section,
wherein the first section is planar to the second section and the first member first flange is connected to the first section and the first member second flange is connected to the second section.

4. The turnstile locking system in claim 1 wherein the first member and the second member are joined by at least one hinge.

5. The turnstile locking system in claim 1 further comprising a locking component that can be inserted through the pin aperture.

6. The turnstile locking system in claim 5 wherein the locking component is a padlock.

7. The turnstile locking system in claim 5 further comprising a blocking structure to block the locking component wherein the blocking structure is attached to the second member.

8. The turnstile locking system in claim 2 wherein the first member is 6½ inches long by 9½ inches wide, the first member first flange and the first member second flange are each 6½ inches long by 2¼ inches wide, the second member is 6½ inches long by 10 inches wide, side lengths of the v-shaped second member face are each 6½ inches long, and the second member first flange and the second member second flange are each 6½ inches long by 3 inches wide.

9. The turnstile locking system in claim 3 wherein the first section and the second section are each 6½ inches long by 2½ inches wide, side lengths of the triangular projection are each 3½ inches long, the first member first flange and the first member second flange are each 6½ inches long by 2¼ inches wide, the second member is 6½ inches long by 10 inches wide, side lengths of the v-shaped second member face are each 6½ inches long, and the second member first flange and the second member second flange are each 6½ inches long by 3 inches wide.

10. The turnstile locking system in claim 1 wherein the pin is 11¾ inches long and one inch in diameter, the pin head is 1¾ inches in diameter, the pin aperture is ½ inches in diameter, and wherein the first member first aperture, the first member second aperture, the second member first aperture, and the second member second aperture are each 1¼ inches in diameter.

11. A turnstile locking system comprising:
(a) a first member comprised of
a first member face,
a first member first flange,
a first member second flange,
a first member first aperture located on the first member first flange, and
a first member second aperture located on the first member second flange,
wherein the first member first flange and the first member second flange are connected to opposite edges of the first member face;
(b) a second member comprising
a v-shaped second member face,
a second member first flange,
a second member second flange,
a second member first aperture located on the second member first flange, and
a second member second aperture located on the second member second flange,
wherein the second member first flange and the second member second flange are connected to opposite edges of the v-shaped second member face; and
(c) a pin comprised of a pin head and a pin aperture adapted to receive a locking component,
wherein the first member engages with the second member to create a channel to enclose a plurality of turnstile bars, the first member engages with the second member by coupling the first member first flange with the second member first flange and the first member second flange with the second member second flange wherein the first member first aperture, the first member second aperture, the second member first aperture, and the second member second aperture all align forming a conduit to receive the pin.

12. The turnstile locking system in claim 11 wherein the first member face is flat and the first member first flange and the first member second flange are connected perpendicularly to the first member face.

13. The turnstile locking system in claim 11 wherein the first member face comprises
a first section,
a second section, and
a triangular projection positioned in between the first section and the second section,
wherein the first section is planar to the second section and the first member first flange is connected perpendicularly to the first section and the first member second flange is connected perpendicularly to the second section.

14. The turnstile locking system in claim 11 wherein the first member and the second member are joined by at least one hinge.

15. The turnstile locking system in claim 11 wherein the locking component is a padlock.

16. The turnstile locking system in claim 11 further comprising a blocking structure to block the locking component wherein the blocking structure is attached to the second member.

17. The turnstile locking system in claim 12 wherein the first member is 6½ inches long by 9½ inches wide, the first member first flange and the first member second flange are each 6½ inches long by 2¼ inches wide, the second member is 6½ inches long by 10 inches wide, side lengths of the v-shaped second member face are each 6½ inches long, and the second member first flange and the second member second flange are each 6½ inches long by 3 inches wide.

18. The turnstile locking system in claim 13 wherein the first section and the second section are each 6½ inches long by 2½ inches wide, side lengths of the triangular projection are each 3½ inches long, the first member first flange and the first member second flange are each 6½ inches long by 2¼ inches wide, the second member is 6½ inches long by 10 inches wide, side lengths of the v-shaped second member face are each 6½ inches long, and the second member first flange and the second member second flange are each 6½ inches long by 3 inches wide.

19. The turnstile locking system in claim 11 wherein the pin is 11¾ inches long and one inch in diameter, the pin head is 1¾ inches in diameter, the pin aperture is ½ inches in diameter, and wherein the first member first aperture, the first member second aperture, the second member first aperture, and the second member second aperture are each 1¼ inches in diameter.

20. A method for securing a turnstile comprising:
(a) providing a turnstile locking device comprised of: (1) a first member comprising a first member face, a first member first flange, a first member second flange, a first member first aperture located on the first member first flange, and a first member second aperture located on the first member second flange, wherein the first member first flange and the first member second flange are connected perpendicularly to opposite edges of the first member face; (2) a second member comprised of a v-shaped second member face, a second member first flange, a second member second flange, a second member first aperture located on the second member first flange, and a second member second aperture located on the second member second flange, wherein the second member first flange and the second member second flange are connected to opposite edges of the v-shaped second member face; and (3) a pin comprised of a pin head and a pin aperture.
(b) positioning the first member and the second member onto a turnstile;
(c) engaging the first member and the second member to create a channel to enclose a plurality of turnstile bars, said engaging is comprised of coupling the first member first flange with the second member first flange, and coupling the first member second flange with the second member second flange, wherein the first member first aperture, the first member second aperture, the second member first aperture, and the second member second aperture align forming a conduit to receive the pin;
(d) inserting the pin through the conduit;
(e) inserting a lock component through the pin aperture; and
(f) locking the lock component to lock the turnstile.
